(19) United States
(12) Patent Application Publication
(10) Pub. No.: US 2023/0085182 A1
(43) Pub. Date: Mar. 16, 2023

(54) Face Mask With Releasable Lower Portion To Enable Eating And Drinking

(71) Applicant: Robert Solomon, Long Beach, NY (US)

(72) Inventor: Robert Solomon, Long Beach, NY (US)

(21) Appl. No.: 17/824,292

(22) Filed: May 25, 2022

Related U.S. Application Data
(60) Provisional application No. 63/193,234, filed on May 26, 2021.

(51) Int. Cl. A62B 18/08

(52) U.S. Cl. CPC A62B 18/086; A62B 18/084; A62B 23/025

(57) ABSTRACT

A face mask is configured in a two-piece form, with an upper portion that covers the nose (and remains in place at all times) and a lower portion that covers the mouth, where the lower portion may be moved (released) to expose the mouth area, without needing to completely remove the mask, as typical in the prior art. A releasable attachment is formed between the bottom area of the upper portion and the top area of the lower portion. The releasable attachment may take many forms, such as a hook-and-loop arrangement, a releasable adhesive, snap connections, and the like.

### CROSS-REFERENCE TO RELATED APPLICATIONS

This application claims the benefit of U.S. Provisional Application No. 63/193,234, filed May 26, 2021 and herein incorporated by reference.

### TECHNICAL FIELD

The present invention relates to a face mask that may be worn to provide protection from air-borne illnesses.

### BACKGROUND OF THE INVENTION

The current COVID-19 pandemic has presented the situation where most people are asked to wear face masks while out in public places (in some jurisdictions, the law requires the wearing of a face mask in certain locations). One location that typically mandates the wearing of a mask is any type of eating establishment.

Obviously, it is impossible to eat or drink while wearing a mask that covers the mouth. The typical solution is to completely remove the mask while eating, which then completely exposes both the nose and mouth for the entire duration of the meal. At times, people may lay their mask on a table while eating, increasing the possibility of attracting bacteria and viruses to the mask. It is also possible that a mask may be removed and left behind at a restaurant.

### SUMMARY OF THE INVENTION

The needs remaining in the prior art are addressed by the present invention, which relates to a face mask that may be worn to provide protection from air-borne illnesses and, more particularly, a face mask with a releasable lower portion for exposing the mouth area, enabling the wearer to eat and drink without having to take the mask off completely.

In accordance with the principles of the present invention, a face mask is configured in a two-piece form, with an upper portion that covers the nose (and remains in place at all times) and a lower portion that covers the mouth, where the lower portion may be moved to expose the mouth area, without needing to completely remove the mask, as typical in the prior art.

In accordance with the teachings of the present invention, a releasable attachment is formed between the bottom area of the upper portion and the top area of the lower portion. The releasable attachment may take many forms, such as a hook-and-loop arrangement, a releasable adhesive, snap connections, and the like.

In an exemplary embodiment of the present invention, the lower portion of the face mask includes a neck strap (such as polyester cording, for example), allowing the lower portion hang out of the way while eating and drinking, yet easily within reach for re-attachment when the meal is complete. In other embodiments, a corner area of the lower portion may be permanently attached to an adjacent corner area of the upper portion, allowing the lower portion to be moved to the side when desired, but not completed detached.

Other and further embodiments and features of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a side view of a typical prior art face mask;

FIG. 2 is a side view of another typical prior art face mask;

FIG. 3 is a side view of an exemplary two-piece face mask formed in accordance with the principles of the present invention;

FIG. 4 illustrates another side view of the two-piece face mask as shown in FIG. 3, in this case with the lower portion dis-engaged to expose a wearer's mouth for eating or drinking;

FIG. 5 is a front view of the inventive two-piece face mask, illustrating the pieces in separate form;

FIG. 6 is a front view of another embodiment of a two-piece face mask formed in accordance with the present invention;

FIG. 7 illustrates an upper portion of the inventive two-piece face mask as in place over the nose area of an individual;

FIG. 8 shows an arrangement of the inventive two-piece face mask with the lower portion in place and attached to the upper portion; and

FIG. 9 is a view of the interior of a lower portion of the inventive two-piece face mask, clearly showing the location of releasable elements that may be used to attach an upper portion to the lower portion, thereby providing complete protection by the inventive two-piece face mask.

### DETAILED DESCRIPTION

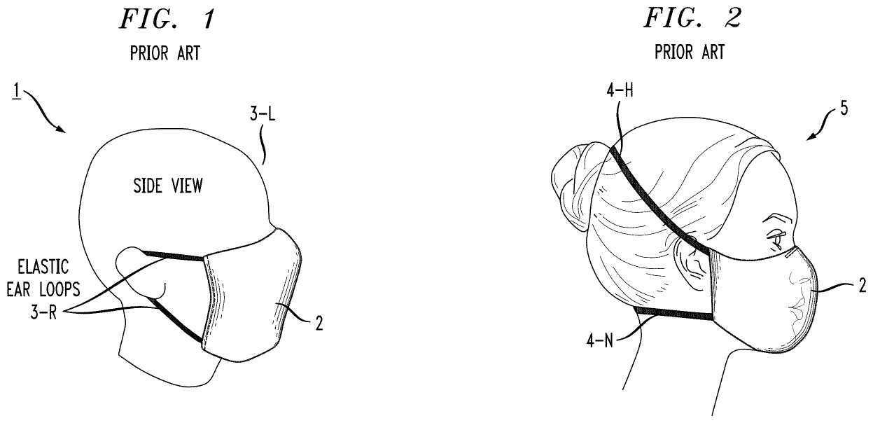

FIG. 1 is a side view of a typical prior art face mask 1 that includes a shielding filter 2 sized to fit over and completely cover the noise and mouth. In this case, a pair of elastic ear loops 3-L, 3-R are attached to the corners of shielding filter 2 and placed around the ears to hold mask 1 in place. That is, ear loop 3-L is attached to at the top and bottom corners of the left-hand side of shielding filter 2 and ear loop 3-R (not visible in this side view) is attached to the top and bottom corners of the right-hand side of shielding filter 2.

FIG. 2 is a side view of another typical prior art face mask, denoted here as prior art face mask 5, where in this case ear loops 3-L, 3-R are replaced by a head loop 4-H and a neck loop 4-N.

In both cases, it is clear that the entire mask needs to be removed whenever the wearer wants to eat or drink. This is the problem solved by the use of a two-piece face mask formed in accordance with the principles of the present invention.

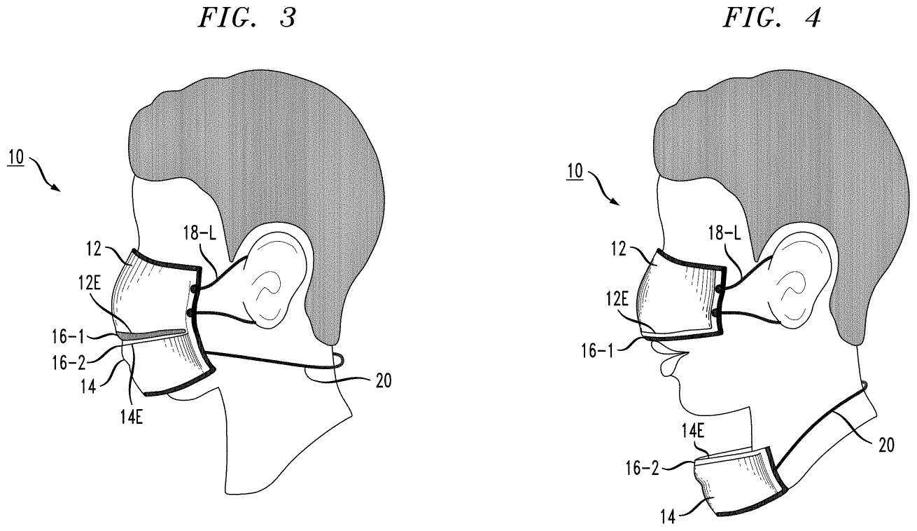

FIG. 3 is a side view of an exemplary two-piece face mask 10 formed in accordance with one embodiment of the present invention. Two-piece face mask 10 is shown as comprising an upper portion 12 that is sized to cover the nose area and a lower portion 14 that covers the mouth area. A releasable attachment 16 (e.g., hook-and-loop, adhesive, snaps, etc.) is included at the interface between upper portion 12 and lower portion 14 to ensure that the two pieces are joined and the face is completely covered when the wearer is not eating or drinking. In particular, releasable attachment 16 includes a first component 16-1 disposed along a bottom edge 12E of upper portion 12 and a second component 16-2 disposed along a top edge 14E of lower portion 14.

In accordance with this embodiment of the present invention, a pair of ear loops 18-L, 18-R are used to hold upper portion 12 in place (in this side view, only ear loop 18-L is visible). A separate attachment cord 20 is affixed to lower portion 14, where attachment cord 20 functions to ensure that the mouth area remains covered when lower portion 14 is attached to upper portion 12. In a preferred embodiment, attachment cord 20 is adjustable, allowing for lower portion 14 to rest in place around the wearer's neck while eating or drinking, as shown in FIG. 4.

Indeed, FIG. 4 illustrates another side view of two-piece face mask 10, in this case where lower portion 14 has been released by the wearer, exposing the mouth area for eating or drinking. In accordance with this embodiment of the present invention, Upper portion remains in place by virtue of ear loops 18-L, 18-R remaining in place. In order to separate lower portion 14 from upper portion 12, the wearer simply pulls the two portions apart (gently) in the area of releasable attachment 16. As shown in FIG. 4, lower portion 14 remains “on” the wearer, now hanging around his/her neck by attachment cord 20.

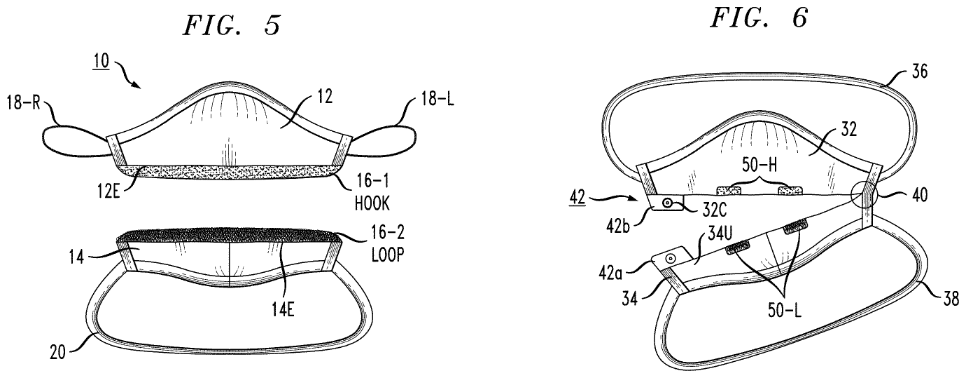

FIG. 5 is a front view of two-piece face mask 10, illustrating the pieces in separate form. Releasable attachment 16 is clearly shown in this view. In particular, for this embodiment of the present invention releasable attachment 16 comprises a hook-and-loop releasable fastener with a strip of the hook element 16-1H disposed along the outer bottom edge 12E of upper portion 12, and a strip of the associated loop element 16-L disposed along the top inner surface of lower portion 14.

FIG. 6 is a front view of another two-piece face mask 30 formed in accordance with the present invention. As with the embodiment discussed above, two-piece face mask 30 includes an upper portion 32 and a lower portion 34, where lower portion 34 is releasably joined to upper portion 32 so that it may be moved to uncover the mouth area for eating or drinking. A head strap 36 is used to secure upper portion 32 in place so that the nose remains covered at all times. Head strap 36 may be an elasticized strap, or a two-piece strap that is tied, snapped or otherwise joined together. A neck strap 38, similar to neck strap 20 discussed above, may be attached to lower portion 34.

In accordance with this particular embodiment of the present invention, lower portion 34 is permanently attached to upper portion 32 at a first corner area 40 so that regardless if lower portion 34 is in the “attached” or “released” configuration, lower portion 34 remains conveniently located for re-attachment without having to completely remove it from face mask 30.

Also shown in FIG. 6 is a releasable attachment 42 formed at a second, opposing corner area 44. In this example, releasable attachment 42 comprises a snap element, with a socket component 42a attached to an upper corner 34U of lower portion 34, and a stud component 42b attached to a lower corner 32C of upper portion 32. In most situations, snap 42 is “closed”, with stud 42b fixed in place within socket 42b such that lower portion 34 of mask 30 is attached to upper portion 32, protecting both the nose and mouth areas. When the wearer wants to eat or drink, he/she merely unsnaps releasable attachment 42, allowing lower portion 34 to drop and hang below permanent attachment 40.

In one exemplary configuration of face mask 30, additional releasable attachment elements 50 (such as short hook-and-loop arrangements) may be positioned along the interface between upper portion 32 and lower portion 34, as shown in FIG. 6, to further ensure that lower portion 34 remains attached to upper portion 32 when the two portions are joined together. Here, a pair of hook elements 50-H are included along the lower edge of upper portion 32 and a pair of loop elements 50-L are included along the top edge of lower portion 34.

FIGS. 7-9 illustrate yet another embodiment of a two-piece face mask formed in accordance with the present invention. Here, a two-piece face mask 60 comprises an upper portion 62 and a lower portion 64. Referring to FIG. 7, upper portion 62 is shown in place over the nose area of an individual, with a head strap 66 used to hold upper portion 62 in place at all times. In accordance with this embodiment of the present invention, head strap 66 includes at least one releasable attachment element 68 positioned at the side of the face, as shown in FIG. 7.

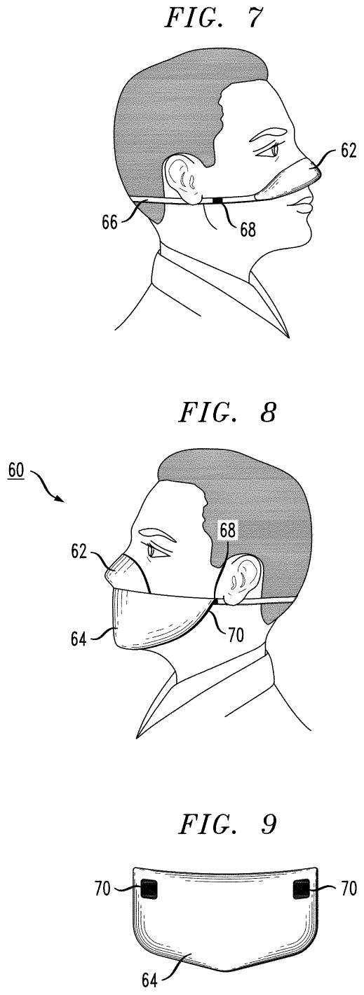

In accordance with the principles of the present invention, lower portion 64 is held in place against upper portion 62 by using releasable attachment a releasable element 70 (see FIG. 9) that mates with releasable element 68 in a manner similar to that discussed above. FIG. 8 shows an arrangement of face mask 60 with lower portion 64 in place and attached to upper portion 62, and FIG. 9 is a view of the interior of lower portion 64, clearly showing the location of releasable elements 70. It is to be understood that in an alternative configuration of this embodiment it is possible to use a “permanent” attachment along one side of head strap 66 and a releasable attachment on the opposite side, similar to the arrangement shown in FIG. 6.

It is to be understood that a two-piece face mask of the present invention may be formed of materials suitable for a disposable face mask (i.e., paper-based masks) or formed of fabric materials used for masks that may be reused. The upper portion of the inventive face mask may include an internal reinforcing strip across the bridge of the nose, as is common in many face mask designs. Similarly, the lower portion may include a venting component, as used in some arrangements.

While the invention has been described with respect to certain embodiments, as well be appreciated by those skilled in the art, it is to be understood that the configurations of the present invention may be capable of numerous changes, modifications and/or rearrangements, with all such changes, modifications and/or rearrangements intended to be covered by the claims appended hereto.

What is claimed is:

1. A two-piece face mask to be worn by a person, comprising
an upper portion sized to cover a nose area of the person, the upper portion including a bottom edge extending across an area of the face below the nose and head securing means for holding the upper portion in place on the face;
a lower portion sized to cover a mouth area of the person, the lower portion including a top edge extending across an area of the face above the mouth and neck securing means for maintaining connection between the lower portion the portion; and
a releasable attachment configuration disposed along the bottom edge of the upper portion and the top edge of the lower portion, providing joining of the upper and lower portions to create a full-coverage face mask while also permitting releasable detachment of the lower portion when desired to access the mouth area.

2. The two-piece face mask as defined in claim 1, wherein the head securing means comprises a pair of ear loops attached to opposing side edges of the upper portion.

3. The two-piece face mask as defined in claim 1, wherein the head securing means comprises an elastic head strap for encircling the person's head to hold the upper portion in place.

4. The two-piece face mask as defined in claim 1, wherein the head securing means comprises a pair of straps to be tied together at the rear of the head to hold the upper portion in place.

5. The two-piece face mask as defined in claim 1, wherein the neck securing means comprises a single-piece cord attached to opposing sides of the lower portion for encircling a person's neck.

6. The two-piece face mask as defined in claim 1, wherein the neck securing means comprises a pair of straps to be tied together to form a loop around the neck area.

7. The two-piece face mask as defined in claim 1 wherein the releasable attachment configuration comprises at least one hook-and-loop releasable fastener, with the hook element disposed along an interface edge of one portion of the upper and lower portions, and the loop element disposed along an interface edge of a remaining portion of the upper and lower portions.

8. The two-piece face mask as defined in claim 1 wherein the releasable attachment configuration comprises at least one snap-together arrangement of a stud and a socket, with the stud element disposed along an interface edge of one portion of the upper and lower portions, and the socket element disposed along an interface edge of a remaining portion of the upper and lower portions.
